(19) United States
(12) Patent Application Publication
(10) Pub. No.: US 2024/0243980 A1
(43) Pub. Date: Jul. 18, 2024

(54) METHOD AND APPARATUS FOR GENERATING EVENT TICKETS

(71) Applicant: RAKUTEN SYMPHONY, INC., Tokyo (JP)

(72) Inventors: Ecem Oyku GECGEL, Tokyo (JP); Rina TAKAMATSU, Tokyo (JP); Bal Vikas NIRALA, Tokyo (JP); Sanyam MADAAN, Tokyo (JP)

(73) Assignee: RAKUTEN SYMPHONY, INC., Tokyo (JP)

(21) Appl. No.: 18/013,109

(22) PCT Filed: Nov. 28, 2022
(86) PCT No.: PCT/US2022/051067

§ 371 Date: Dec. 27, 2022

(51) Int. Cl. H04L 41/5074; H04L 41/06

(52) U.S. Cl. CPC H04L 41/5074; H04L 41/06

(57) ABSTRACT

A method performed by at least one processor for generating an event ticket includes receiving, for at least one user, a selection of a network quality category from a plurality of network quality categories. The method includes receiving a selection of an alarm associated with the selected network quality category. The method includes receiving a selection of at least one threshold for the selected alarm. The method includes determining a number of times the alarm is triggered within a predetermined time period. The method further includes generating the event ticket in response to a determination the number of times the alarm is triggered within the predetermined time period exceeds the at least one threshold.

### TECHNICAL FIELD

The present disclosure relates generally to communication systems, and more particularly to methods and apparatuses for generating even tickets.

### BACKGROUND

On average, a network engineer spends one-third of their working day navigating between various systems to monitor customer experience and handle complaints. The network engineer needs to view large amounts of data and manually create tickets to track the customer complaints. For the same issue, engineers in a shift open separate tickets adding to the pile of tickets, most of which are neglected and left unresolved.

Conventional systems do not offer the capability to monitor a customer's experience from all aspects in a single system, or to generate automatic tickets. These systems do not appropriate profiling of the customer. Furthermore, there is no unified system to perceive, understand, and conclude required actions of VIP end user experience in the network at one place. Conventional systems do not provide rule based logic creation to detect customer issues/possible customer complaints or provide correlation of the network incidents with the customer's performance. Conventional systems also fail to provide impact analysis on a user level, a device level, and a service level. For example, conventional systems do not provide network incidents and how these incidents impacts users/and their effect on every user. Furthermore, a network engineering team uses a 3^{rd} party Trace Engine, and requests to add conditions one by one. Furthermore, there is no proper RCA and permanent fix are provided because of not being able to link the incidents with customer experience. As a result of these issues, a lot of problems are solved too late, or remain unsolved.

Improvements are presented herein. These improvements may also be applicable to other multi-access technologies and the telecommunication standards that employ these technologies.

### SUMMARY

The following presents a simplified summary of one or more embodiments of the present disclosure in order to provide a basic understanding of such embodiments. This summary is not an extensive overview of all contemplated embodiments, and is intended to neither identify key or critical elements of all embodiments nor delineate the scope of any or all embodiments. Its sole purpose is to present some concepts of one or more embodiments of the present disclosure in a simplified form as a prelude to the more detailed description that is presented later.

Methods, apparatuses, and non-transitory computer-readable mediums for visualizing user profiles and generating event tickets are disclosed by the present disclosure.

According to an exemplary embodiment, a method performed by at least one processor for generating an event ticket includes receiving, for at least one user, a selection of a network quality category from a plurality of network quality categories. The method includes receiving a selection of an alarm associated with the selected network quality category. The method includes receiving a selection of at least one threshold for the selected alarm. The method includes determining a number of times the alarm is triggered within a predetermined time period. The method further includes generating the event ticket in response to a determination the number of times the alarm is triggered within the predetermined time period exceeds the at least one threshold.

According to an exemplary embodiment, an apparatus for generating an event ticket includes at least one memory configured to store computer program code, and at least one processor configured to access the at least one memory and operate as instructed by the computer program code. The computer program code includes first receiving, code configured to cause at least one of said at least one processor to receive for at least one user, a selection of a network quality category from a plurality of network quality categories. The computer code includes second receiving code configured to cause at least one of said at least one processor to receive a selection of an alarm associated with the selected network quality category. The computer code includes third receiving code configured to cause at least one of said at least one processor to receive a selection of at least one threshold for the selected alarm. The computer code further includes determining code configured to cause at least one of said at least one processor to determine a number of times the alarm is triggered within a predetermined time period. The computer code further includes generating code configured to cause at least one of said at least one processor to generate the event ticket in response to a determination the number of times the alarm is triggered within the predetermined time period exceeds the at least one threshold.

According to an exemplary embodiment, a non-transitory computer readable medium having instructions stored therein, which when executed by a processor cause the processor to execute a method performed by at least one processor for generating an event ticket. The method includes receiving, for at least one user, a selection of a network quality category from a plurality of network quality categories. The method includes receiving a selection of an alarm associated with the selected network quality category. The method includes receiving a selection of at least one threshold for the selected alarm. The method includes determining a number of times the alarm is triggered within a predetermined time period. The method further includes generating the event ticket in response to a determination the number of times the alarm is triggered within the predetermined time period exceeds the at least one threshold.

Additional embodiments will be set forth in the description that follows and, in part, will be apparent from the description, and/or may be learned by practice of the presented embodiments of the disclosure.

### BRIEF DESCRIPTION OF THE DRAWINGS

The above and other aspects, features, and aspects of embodiments of the disclosure will be apparent from the following description taken in conjunction with the accompanying drawings, in which:

FIG. 1 is a diagram of an example network device in accordance with various embodiments of the present disclosure.

FIG. 2 is a schematic diagram of an example wireless communications system, in accordance with various embodiments of the present disclosure.

FIG. 3 is a diagram of a system for generating tickets.

FIG. 4 is a diagram of a trace engine data integration flow.

FIG. 5 illustrates an example graphical user interface (GUI) for displaying and selecting categories, in accordance with various embodiments of the present disclosure.

FIG. 6 illustrates an example GUI for displaying and selecting alarms and corresponding thresholds, in accordance with various embodiments of the present disclosure.

FIG. 7 illustrates an example GUI for displaying an example user profile, in accordance with various embodiments of the present disclosure.

FIG. 8 illustrates an example priority matrix, in accordance with various embodiments of the present disclosure.

FIG. 9 illustrates a flowchart of an embodiment of a process for performing beam management.

### DETAILED DESCRIPTION

The following detailed description of example embodiments refers to the accompanying drawings. The same reference numbers in different drawings may identify the same or similar elements.

The foregoing disclosure provides illustration and description, but is not intended to be exhaustive or to limit the implementations to the precise form disclosed. Modifications and variations are possible in light of the above disclosure or may be acquired from practice of the implementations. Further, one or more features or components of one embodiment may be incorporated into or combined with another embodiment (or one or more features of another embodiment). Additionally, in the flowcharts and descriptions of operations provided below, it is understood that one or more operations may be omitted, one or more operations may be added, one or more operations may be performed simultaneously (at least in part), and the order of one or more operations may be switched.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware may be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Where only one item is intended, the term “one” or similar language is used. Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B]” or “at least one of [A] or [B]” are to be understood as including only A, only B, or both A and B.

Reference throughout this specification to “one embodiment,” “an embodiment,” or similar language means that a particular feature, structure, or characteristic described in connection with the indicated embodiment is included in at least one embodiment of the present solution. Thus, the phrases “in one embodiment”, “in an embodiment,” and similar language throughout this specification may, but do not necessarily, all refer to the same embodiment.

Furthermore, the described features, advantages, and characteristics of the present disclosure may be combined in any suitable manner in one or more embodiments. One skilled in the relevant art will recognize, in light of the description herein, that the present disclosure can be practiced without one or more of the specific features or advantages of a particular embodiment. In other instances, additional features and advantages may be recognized in certain embodiments that may not be present in all embodiments of the present disclosure.

Embodiments of the present disclosure are directed to automatically generating tickets. According to some embodiments, a graphical user interface (GUI) is provided to create auto ticketing logic based on alarms. A user may be able to select an alarm category or a network quality category. The categories are issues for which an alarm may be raised. Possible categories include, but are not limited to, Volte-RCS Voice Quality, Release Cause Anomaly, Out Of Service, Low RSRP, Roaming, IMSI or IMEI Change, Poor Video Streaming, etc.

The selection of categories may be performed based on multiple parameters such as network performance, traffic in network, and/or other factors. After category selection, a user may be able to select a column (e.g., “Column” may refer to a column of a data table). For example, alarms may have pre-defined data fields. These fields may vary based on category, and may be predetermined for each category. These fields may be stored in an applications DB, and set a threshold. As an example, the threshold may correspond to a criteria where if a value is less than the threshold, an alarm is not triggered. If the value is greater than the threshold, an alarm may be automatically triggered where an action may be performed by the system depending on how many times the alarm is triggered. For example, users may set criteria that if roaming data exceeds 1 GB (e.g., threshold), and if the alarm is triggered 5 times in a day (e.g., frequency or occurrence), then an auto ticket may be created.

If the same alarm is received frequently (e.g., threshold is exceeded multiple times within a time period), then a ticket may be created. Furthermore, a priority may be defined based on the alarm category. In some embodiments, the priority may be defined based on a matrix calculation and impact and an urgency calculation. In some embodiments, to define a priority, values may be predetermined as master data in a ticket management system. A priority matrix may be set based on impact and urgency. Each type of alarm may have different impacts and urgency based on how the user experience is affected, which may be further defined on the business side.

According to some embodiment, a user profile may be created to store in a database and track user behavior. For example, the user behavior may indicate a call drop at a same location every day. The embodiments of the present disclosure result in all relevant data being stored in one place, thereby reducing the need of logging to different tools to detect an incident. The embodiments of the present disclosure further provide a fully detailed customer journey for VIP users with customized alarms and tailor ticketing to assure premium experience. Tailor ticketing may refer to having auto ticket creation mechanisms based on alarms and criteria so that immediate action may be taken when customer experience is being affected. The embodiments of the present disclosure may further provide insights of what type of issues and what services are impacted for VIP users.

The embodiments of the present disclosure also result in the following advantages: (i) reduction in unresolved customer tickets, (ii) optimized handling of customer complaints to increase Net Promoter Score (NPS), (iii) assure right profiling of the customer and proactively tackling silent experience issues and addressing VIP Complaints, and (iv) decreasing a mean time to resolve issues by introducing rule-based algorithms which may ease the process of troubleshooting.

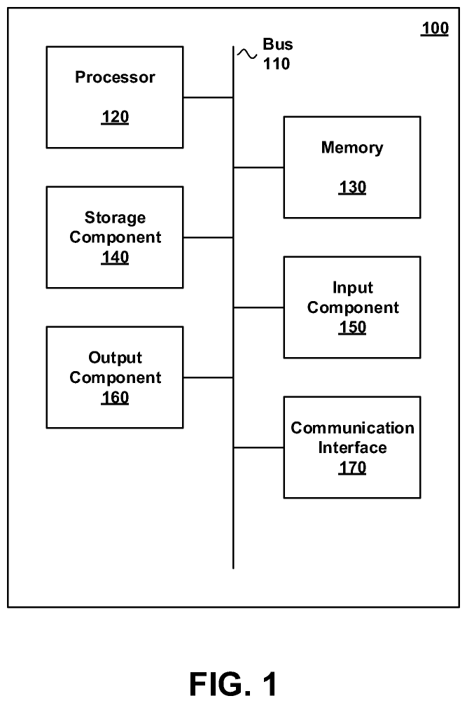

FIG. 1 is diagram of an example device for performing the embodiments of the present disclosure. Device 100 may correspond to any type of known computer, server, or data processing device. For example, the device 100 may comprise a processor, a personal computer (PC), a printed circuit board (PCB) comprising a computing device, a mini-computer, a mainframe computer, a microcomputer, a telephonic computing device, a wired/wireless computing device (e.g., a smartphone, a personal digital assistant (PDA)), a laptop, a tablet, a smart device, or any other similar functioning device.

In some embodiments, as shown in FIG. 1, the device 100 may include a set of components, such as a processor 120, a memory 130, a storage component 140, an input component 150, an output component 160, and a communication interface 170.

The bus 110 may comprise one or more components that permit communication among the set of components of the device 100. For example, the bus 110 may be a communication bus, a cross-over bar, a network, or the like. Although the bus 110 is depicted as a single line in FIG. 1, the bus 110 may be implemented using multiple (two or more) connections between the set of components of device 100. The disclosure is not limited in this regard.

The device 100 may comprise one or more processors, such as the processor 120. The processor 120 may be implemented in hardware, firmware, and/or a combination of hardware and software. For example, the processor 120 may comprise a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), a general purpose single-chip or multi-chip processor, or other programmable logic device, discrete gate or transistor logic, discrete hardware components, or any combination thereof designed to perform the functions described herein. A general purpose processor may be a microprocessor, or any conventional processor, controller, microcontroller, or state machine. The processor 120 also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function.

The processor 120 may control overall operation of the device 100 and/or of the set of components of device 100 (e.g., the memory 130, the storage component 140, the input component 150, the output component 160, the communication interface 170).

The device 100 may further comprise the memory 130. In some embodiments, the memory 130 may comprise a random access memory (RAM), a read only memory (ROM), an electrically erasable programmable ROM (EEPROM), a flash memory, a magnetic memory, an optical memory, and/or another type of dynamic or static storage device. The memory 130 may store information and/or instructions for use (e.g., execution) by the processor 120.

The storage component 140 of device 100 may store information and/or computer-readable instructions and/or code related to the operation and use of the device 100. For example, the storage component 140 may include a hard disk (e.g., a magnetic disk, an optical disk, a magneto-optic disk, and/or a solid state disk), a compact disc (CD), a digital versatile disc (DVD), a universal serial bus (USB) flash drive, a Personal Computer Memory Card International Association (PCMCIA) card, a floppy disk, a cartridge, a magnetic tape, and/or another type of non-transitory computer-readable medium, along with a corresponding drive.

The device 100 may further comprise the input component 150. The input component 150 may include one or more components that permit the device 100 to receive information, such as via user input (e.g., a touch screen, a keyboard, a keypad, a mouse, a stylus, a button, a switch, a microphone, a camera, and the like). Alternatively or additionally, the input component 150 may include a sensor for sensing information (e.g., a global positioning system (GPS) component, an accelerometer, a gyroscope, an actuator, and the like).

The output component 160 of device 100 may include one or more components that may provide output information from the device 100 (e.g., a display, a liquid crystal display (LCD), light-emitting diodes (LEDs), organic light emitting diodes (OLEDs), a haptic feedback device, a speaker, and the like).

The device 100 may further comprise the communication interface 170. The communication interface 170 may include a receiver component, a transmitter component, and/or a transceiver component. The communication interface 170 may enable the device 100 to establish connections and/or transfer communications with other devices (e.g., a server, another device). The communications may be effected via a wired connection, a wireless connection, or a combination of wired and wireless connections. The communication interface 170 may permit the device 100 to receive information from another device and/or provide information to another device. In some embodiments, the communication interface 170 may provide for communications with another device via a network, such as a local area network (LAN), a wide area network (WAN), a metropolitan area network (MAN), a private network, an ad hoc network, an intranet, the Internet, a fiber optic-based network, a cellular network (e.g., a fifth generation (5G) network, a long-term evolution (LTE) network, a third generation (3G) network, a code division multiple access (CDMA) network, and the like), a public land mobile network (PLMN), a telephone network (e.g., the Public Switched Telephone Network (PSTN)), or the like, and/or a combination of these or other types of networks. Alternatively or additionally, the communication interface 170 may provide for communications with another device via a device-to-device (D2D) communication link, such as FlashLinQ, WiMedia, Bluetooth, ZigBee, Wi-Fi, LTE, 5G, and the like. In other embodiments, the communication interface 170 may include an Ethernet interface, an optical interface, a coaxial interface, an infrared interface, a radio frequency (RF) interface, or the like.

The device 100 may perform one or more processes described herein. The device 100 may perform operations based on the processor 120 executing computer-readable instructions and/or code that may be stored by a non-transitory computer-readable medium, such as the memory 130 and/or the storage component 140. A computer-readable medium may refer to a non-transitory memory device. A memory device may include memory space within a single physical storage device and/or memory space spread across multiple physical storage devices.

Computer-readable instructions and/or code may be read into the memory 130 and/or the storage component 140 from another computer-readable medium or from another device via the communication interface 170. The computer-readable instructions and/or code stored in the memory 130 and/or storage component 140, if or when executed by the processor 120, may cause the device 100 to perform one or more processes described herein.

Alternatively or additionally, hardwired circuitry may be used in place of or in combination with software instructions to perform one or more processes described herein. Thus, embodiments described herein are not limited to any specific combination of hardware circuitry and software.

The number and arrangement of components shown in FIG. 1 are provided as an example. In practice, there may be additional components, fewer components, different components, or differently arranged components than those shown in FIG. 1. Furthermore, two or more components shown in FIG. 1 may be implemented within a single component, or a single component shown in FIG. 1 may be implemented as multiple, distributed components. Additionally or alternatively, a set of (one or more) components shown in FIG. 1 may perform one or more functions described as being performed by another set of components shown in FIG. 1.

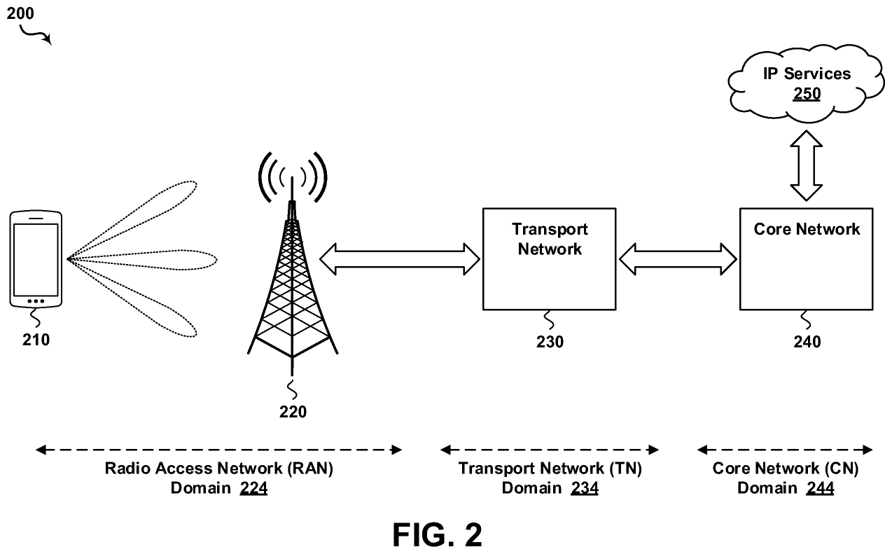

FIG. 2 is a diagram illustrating an example of a wireless communications system, according to various embodiments of the present disclosure. The wireless communications system 200 (which may also be referred to as a wireless wide area network (WWAN)) may include one or more user equipment (UE) 210, one or more base stations 220, at least one transport network 230, and at least one core network 240. The device 100 (FIG. 1) may be incorporated in the UE 210 or the base station 220.

The one or more UEs 210 may access the at least one core network 240 and/or IP services 250 via a connection to the one or more base stations 220 over a RAN domain 224 and through the at least one transport network 230. Examples of UEs 210 may include a cellular phone, a smart phone, a session initiation protocol (SIP) phone, a laptop, a personal digital assistant (PDA), a satellite radio, a global positioning system (GPS), a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similarly functioning device. Some of the one or more UEs 210 may be referred to as Internet-of-Things (IoT) devices (e.g., parking meter, gas pump, toaster, vehicles, heart monitor, etc.). The one or more UEs 210 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile agent, a client, or some other suitable terminology.

The one or more base stations 220 may wirelessly communicate with the one or more UEs 210 over the RAN domain 224. Each base station of the one or more base stations 220 may provide communication coverage to one or more UEs 210 located within a geographic coverage area of that base station 220. In some embodiments, as shown in FIG. 2, the base station 220 may transmit one or more beamformed signals to the one or more UEs 210 in one or more transmit directions. The one or more UEs 210 may receive the beamformed signals from the base station 220 in one or more receive directions. Alternatively or additionally, the one or more UEs 210 may transmit beamformed signals to the base station 220 in one or more transmit directions. The base station 220 may receive the beamformed signals from the one or more UEs 210 in one or more receive directions.

The one or more base stations 220 may include macrocells (e.g., high power cellular base stations) and/or small cells (e.g., low power cellular base stations). The small cells may include femtocells, picocells, and microcells. A base station 220, whether a macrocell or a large cell, may include and/or be referred to as an access point (AP), an evolved (or evolved universal terrestrial radio access network (E-UTRAN)) Node B (eNB), a next-generation Node B (gNB), or any other type of base station known to one of ordinary skill in the art.

The one or more base stations 220 may be configured to interface (e.g., establish connections, transfer data, and the like) with the at least one core network 240 through at least one transport network 230. In addition to other functions, the one or more base stations 220 may perform one or more of the following functions: transfer of data received from the one or more UEs 210 (e.g., uplink data) to the at least one core network 240 via the at least one transport network 230, transfer of data received from the at least one core network 240 (e.g., downlink data) via the at least one transport network 230 to the one or more UEs 210.

The transport network 230 may transfer data (e.g., uplink data, downlink data) and/or signaling between the RAN domain 224 and the CN domain 244. For example, the transport network 230 may provide one or more backhaul links between the one or more base stations 220 and the at least one core network 240. The backhaul links may be wired or wireless.

The core network 240 may be configured to provide one or more services (e.g., enhanced mobile broadband (eMBB), ultra-reliable low-latency communications (URLLC), and massive machine type communications (mMTC), etc.) to the one or more UEs 210 connected to the RAN domain 224 via the TN domain 234. Alternatively or additionally, the core network 240 may serve as an entry point for the IP services 250. The IP services 250 may include the Internet, an intranet, an IP multimedia subsystem (IMS), a streaming service (e.g., video, audio, gaming, etc.), and/or other IP services.

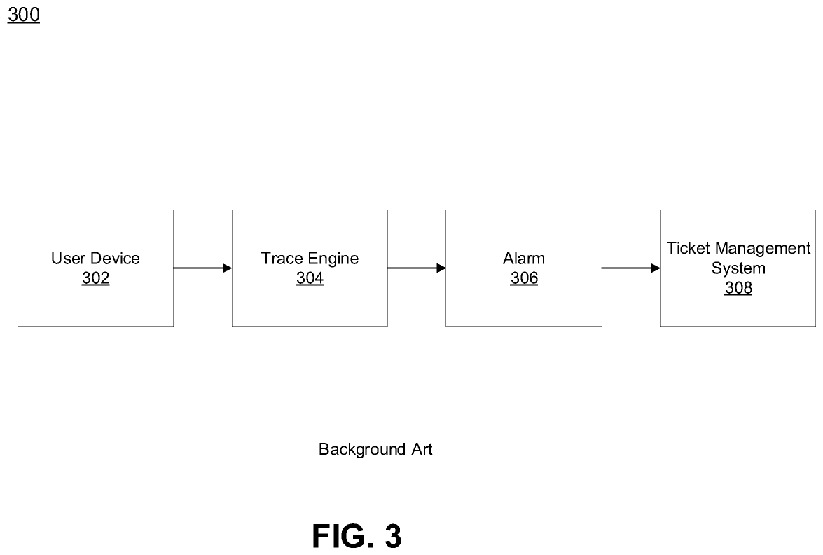

FIG. 3 illustrates an example conventional system having a user device 302, trace engine 304, alarm 306, and ticket management system 308. The trace engine 304 may be a 3^{rd} party trace engine in which network engineers manually create tickets on an individual basis, which is very time consuming and inefficient.

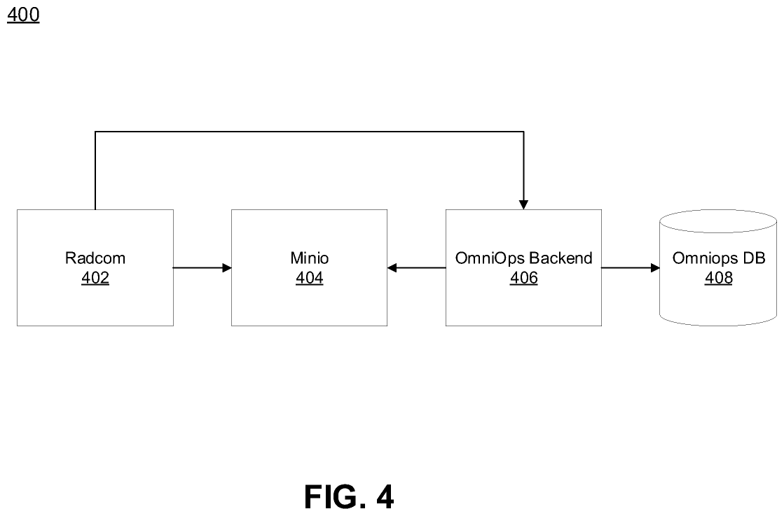

FIG. 4 illustrates an example system 400 for trace engine data integration flow, according to some embodiments. The Radcom 402 may be a probing tool to check a status of a network. The Radcom 402 may collect and push files to Minio 404. The Radcom may also push an event/web hook call to OmniOps Backend 406 whenever there may be new files placed on Minio 404. The OmniOps Backend 406 may be used to create the logic for the alarms and ticket generation. The OmniOps Backend 406 may go to Minio 404 to read files. Furthermore, the OmniOps Backend 406 may read files and store information in the OmniOps DB 408. For example the OmniOps DB 408, for a user, may store 15 days of data indicating how many times a threshold was exceeded during this time period. The OmniOps DB 408 may also store mapping information that maps a mobile ID to a particular customer.

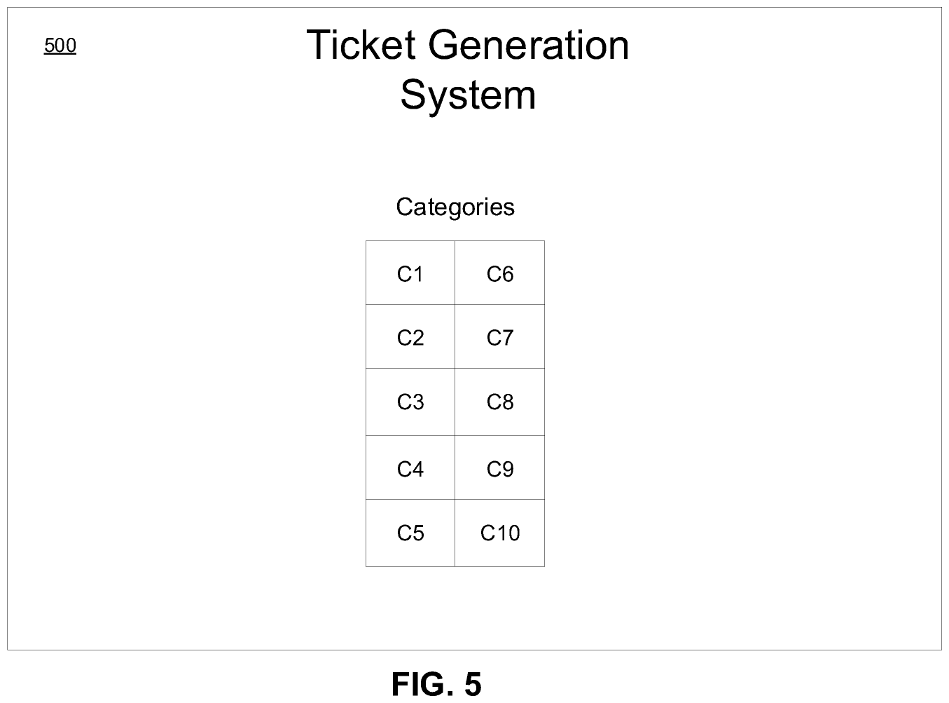

FIG. 5 illustrates an example GUI 500 for a ticket generation system. The GUI 500 may provide a selection of categories C1-C10. The categories may correspond to any one of the aforementioned alarm categories or network quality categories.

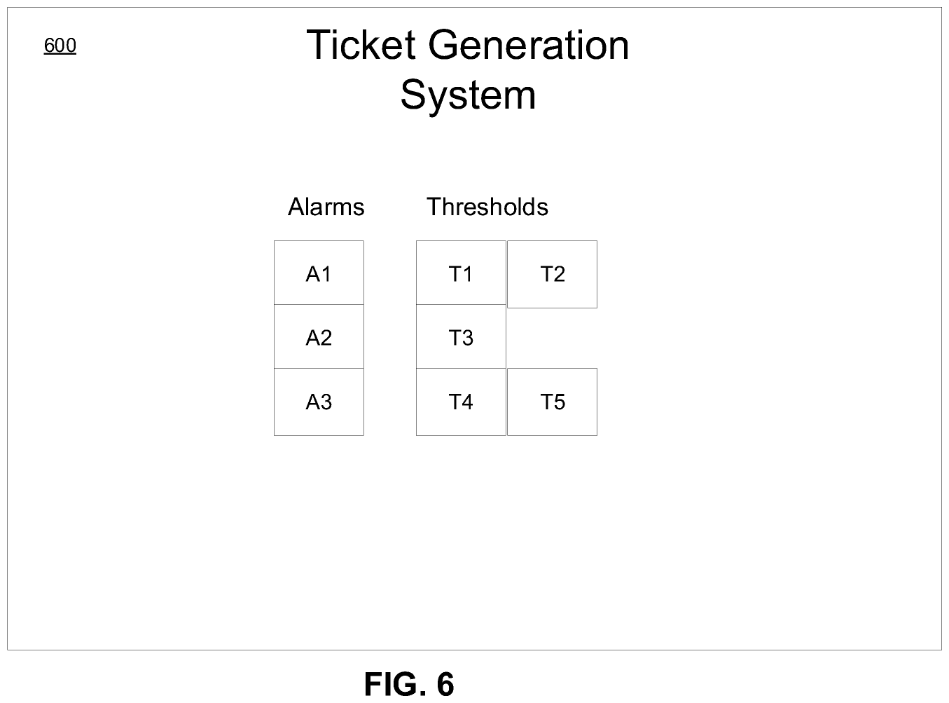

FIG. 6 illustrates an example GUI 600 that may be displayed upon selection of a category. For example, a display may be switched from GUI 500 to GUI 600 upon selection of category C1. The GUI 600 may provide configuration options of alarms for a selected category (e.g., C1). For example, for the selected category, alarms A1-A3 are available. Each alarm may be associated with one or more thresholds. For example, alarm A1 may be associated with thresholds T1 and T2, alarm A2 may be associated with threshold T3, and alarm A3 may be associated with thresholds T4 and T5. As an example, if category C1 corresponds to call drops, threshold T1 may specify a number of occurrences, and threshold T2 may specify a time period. For example, if alarm A1 is selected, the alarm A1 may be triggered if call drops occur 5 or more times (e.g., threshold T1) within a 24 hour period (e.g., threshold T2).

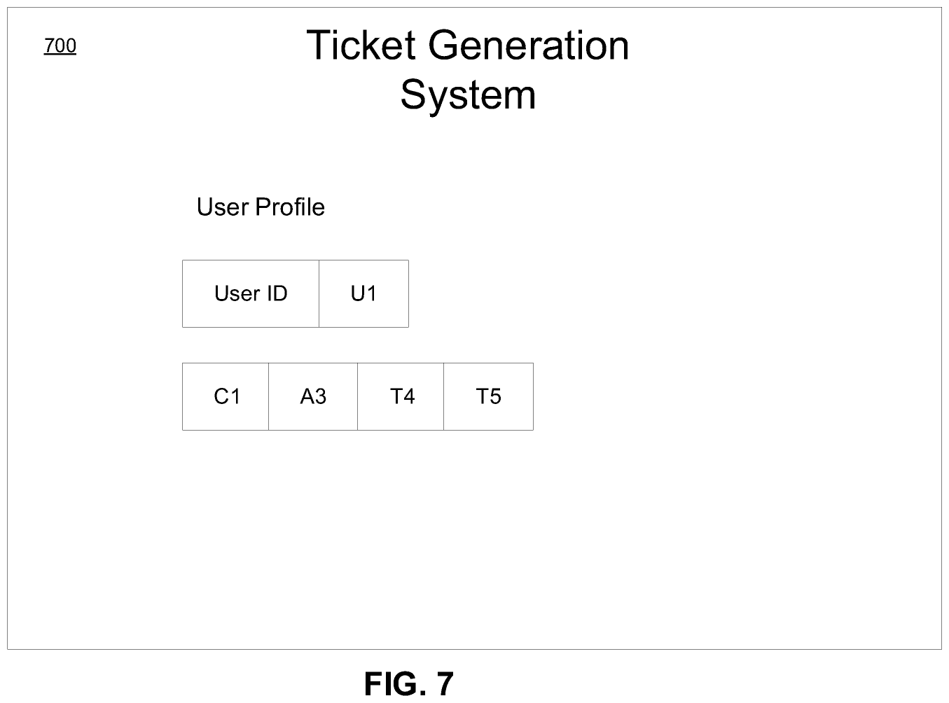

FIG. 7 illustrates an example GUI 700 for displaying an example user profile. For example, as illustrated in FIG. 7, the user profile may indicate a user ID U1 (e.g., IMSI or IMEI). The user profile may further indicate a selected category, alarm, and thresholds. For example, as illustrated in FIG. 7, the user selected category C1 and alarm A3 with thresholds T4 and T5.

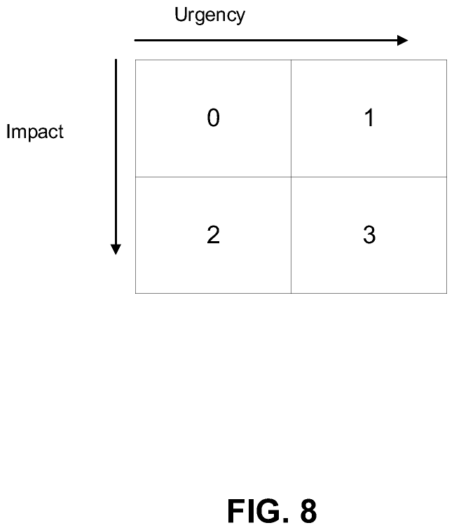

FIG. 8 illustrates an example priority matrix that may assign a priority level based on impact and urgency. As an example, as illustrated in FIG. 8, there are four priority levels with priority level 0 being the lowest priority. As illustrated in FIG. 8, as the impact and urgency of a category increases, the priority level increases. Each category available to a user may be associated with an impact score and an urgency score, where the category and associated alarms may be assigned a priority level in accordance with the priority matrix based on the impact score and urgency score.

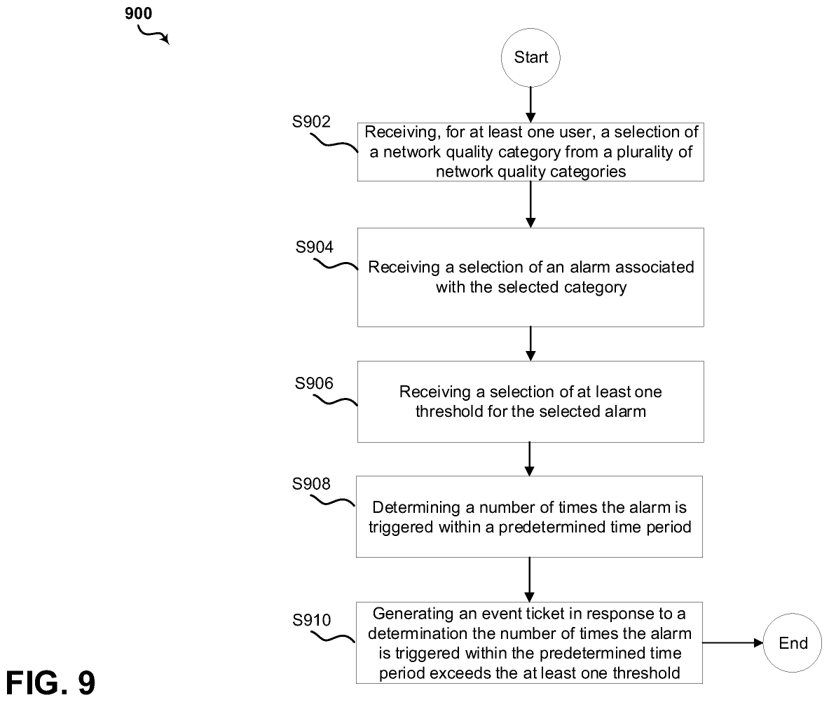

FIG. 9 illustrates an example flowchart of a process 900 for automatically generating tickets. The process 900 may start at operation S902 where a selection of a network quality category from a plurality of network quality categories is received. For example, the network quality categories may include, but are not limited to, Volte-RCS Voice Quality, Release Cause Anomaly, Out Of Service, Low RSRP, Roaming, IMSI or IMEI Change, Poor Video Streaming, etc. These categories may correspond to categories C1-C10 displayed in FIG. 5.

The process proceeds to operation S904 where a selection of an alarm associated with the selected category is received. For example, after the selection of a category displayed in GUI 500 (FIG. 5), the GUI 600 (FIG. 6) may be displayed providing a selection of alarms A1-A3 for the selected category. The process proceeds to operation S906 where a selection of at least one threshold for the selected alarm is received. For example, as illustrated in FIG. 6, after selection of an alarm, the thresholds for the alarm may be configured or selected. As an example, the thresholds may specify a condition for activating an alarm (e.g., 1 GB roaming data threshold) as well as a number of times an alarm may be activated within a time period to generate an event ticket (e.g., event ticket generated if alarm trigger 5 or more times in a 24 hour period). The process proceeds to operation S908, where it is determined a number of times the alarm is triggered within a predetermined time period. For example, the network data for the past 5-15 days may be extracted for a particular user and analyzed to determine whether to generate a ticket. The process proceeds to operation S910 where an event ticket is generated in response to a determination the number of times the alarm is triggered within the predetermined time period exceeds the at least one threshold (e.g., alarm trigger 5 or more times in a 25 hour period).

The foregoing disclosure provides illustration and description, but is not intended to be exhaustive or to limit the implementations to the precise form disclosed. Modifications and variations are possible in light of the above disclosure or may be acquired from practice of the implementations.

It is understood that the specific order or hierarchy of blocks in the processes/flowcharts disclosed herein is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

Some embodiments may relate to a system, a method, and/or a computer readable medium at any possible technical detail level of integration. Further, one or more of the above components described above may be implemented as instructions stored on a computer readable medium and executable by at least one processor (and/or may include at least one processor). The computer readable medium may include a computer-readable non-transitory storage medium (or media) having computer readable program instructions thereon for causing a processor to carry out operations.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program code/instructions for carrying out operations may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects or operations.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer readable media according to various embodiments. In this regard, each block in the flowchart or block diagrams may represent a module, segment, or portion of instructions, which comprises one or more executable instructions for implementing the specified logical function(s). The method, computer system, and computer readable medium may include additional blocks, fewer blocks, different blocks, or differently arranged blocks than those depicted in the Figures. In some alternative implementations, the functions noted in the blocks may occur out of the order noted in the Figures. For example, two blocks shown in succession may, in fact, be executed concurrently or substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware may be designed to implement the systems and/or methods based on the description herein.

The above disclosure also encompasses the embodiments listed below:

(1) A method performed by at least one processor for generating an event ticket, the method including receiving, for at least one user, a selection of a network quality category from a plurality of network quality categories: receiving a selection of an alarm associated with the selected network quality category: receiving a selection of at least one threshold for the selected alarm; determining a number of times the alarm is triggered within a predetermined time period: and generating the event ticket in response to a determination the number of times the alarm is triggered within the predetermined time period exceeds the at least one threshold.

(2) The method according to feature (1), in which the plurality of network quality categories include one or more of (i) voice over long term evolution (Volte) rich communication services (RCS) voice quality, (ii) release cause anomaly, (iii) out of service, (iv) low reference signal received power (RSRP), (v) roaming, (vi) international mobile subscriber identity (IMSI) change, (vii) international mobile equipment identity (IMEI) change, and (viii) poor video quality.

(3) The method according to feature (1) or (2), in which the determining the number of times the alarm is trigger is based on collected network data for the at least one user.

(4) The method according to feature (3), in which the collected network data for the at least one user is extracted from network data for a plurality of users.

(5) The method according to feature (3) or (4), in which the collected network data for the at least one user, the selected alarm, and the selected at least one threshold are associated with a user profile of the at least one user.

(6) The method according to any one of features (1)-(5), in which a priority of the generated event ticket is determined based on a priority matrix that assigned a priority level based on impact and urgency of the alarm.

(7) The method according to any one of features (1)-(6), further including: providing a graphical user interface to the at least one user, in which the selection of the network quality category, the alarm, and the at least one threshold, is based on one or more selections made in the graphical user interface.

(8) An apparatus for generating an event ticket, the apparatus including: at least one memory configured to store computer program code: and at least one processor configured to access said at least one memory and operate as instructed by the computer program code, the computer program code including: first receiving, code configured to cause at least one of said at least one processor to receive for at least one user, a selection of a network quality category from a plurality of network quality categories: second receiving code configured to cause at least one of said at least one processor to receive a selection of an alarm associated with the selected network quality category: third receiving code configured to cause at least one of said at least one processor to receive a selection of at least one threshold for the selected alarm; determining code configured to cause at least one of said at least one processor to determine a number of times the alarm is triggered within a predetermined time period: and generating code configured to cause at least one of said at least one processor to generate the event ticket in response to a determination the number of times the alarm is triggered within the predetermined time period exceeds the at least one threshold.

(9) The apparatus according to feature (8), in which the plurality of network quality categories include one or more of (i) voice over long term evolution (Volte) rich communication services (RCS) voice quality, (ii) release cause anomaly, (iii) out of service, (iv) low reference signal received power (RSRP), (v) roaming, (vi) international mobile subscriber identity (IMSI) change, (vii) international mobile equipment identity (IMEI) change, and (viii) poor video quality.

(10) The apparatus according to feature (8) or (9), in which the determining the number of times the alarm is trigger is based on collected network data for the at least one user.

(11) The apparatus according to feature (10), in which the collected network data for the at least one user is extracted from network data for a plurality of users.

(12) The apparatus according to feature (10) or (11), in which the collected network data for the at least one user, the selected alarm, and the selected at least one threshold are associated with a user profile of the at least one user.

(13) The apparatus according to any one of features (10)-(12), in which a priority of the generated event ticket is determined based on a priority matrix that assigned a priority level based on impact and urgency of the alarm.

(14) The apparatus according to any one of features (8)-(13), further including: providing a graphical user interface to the at least one user, in which the selection of the network quality category, the alarm, and the at least one threshold, is based on one or more selections made in the graphical user interface.

(15) A non-transitory computer readable medium having instructions stored therein, which when executed by a processor cause the processor to execute a method performed by at least one processor for generating an event ticket, the method including: receiving, for at least one user, a selection of a network quality category from a plurality of network quality categories: receiving a selection of an alarm associated with the selected network quality category: receiving a selection of at least one threshold for the selected alarm: determining a number of times the alarm is triggered within a predetermined time period: and generating the event ticket in response to a determination the number of times the alarm is triggered within the predetermined time period exceeds the at least one threshold.

(16) The non-transitory computer readable medium according to feature (15), in which the plurality of network quality categories include one or more of (i) voice over long term evolution (Volte) rich communication services (RCS) voice quality, (ii) release cause anomaly, (iii) out of service, (iv) low reference signal received power (RSRP), (v) roaming, (vi) international mobile subscriber identity (IMSI) change, (vii) international mobile equipment identity (IMEI) change, and (viii) poor video quality.

(17) The non-transitory computer readable medium according to feature (15) or (16), in which the determining the number of times the alarm is trigger is based on collected network data for the at least one user.

(18) The non-transitory computer readable medium according to feature (17), in which the collected network data for the at least one user is extracted from network data for a plurality of users.

(19) The non-transitory computer readable medium according to feature (17) or (18), in which the collected network data for the at least one user, the selected alarm, and the selected at least one threshold are associated with a user profile of the at least one user.

(20) The non-transitory computer readable medium according to any one of features (15)-(19), in which a priority of the generated event ticket is determined based on a priority matrix that assigned a priority level based on impact and urgency of the alarm.

What is claimed is:

1. A method performed by at least one processor for generating an event ticket, the method comprising:
receiving, for at least one user, a selection of a network quality category from a plurality of network quality categories;
receiving a selection of an alarm associated with the selected network quality category;
receiving a selection of at least one threshold for the selected alarm;
determining a number of times the alarm is triggered within a predetermined time period; and
generating the event ticket in response to a determination the number of times the alarm is triggered within the predetermined time period exceeds the at least one threshold.

2. The method according to claim 1, wherein the plurality of network quality categories include one or more of (i) voice over long term evolution (Volte) rich communication services (RCS) voice quality, (ii) release cause anomaly, (iii) out of service, (iv) low reference signal received power (RSRP), (v) roaming, (vi) international mobile subscriber identity (IMSI) change, (vii) international mobile equipment identity (IMEI) change, and (viii) poor video quality.

3. The method according to claim 1, wherein the determining the number of times the alarm is trigger is based on collected network data for the at least one user.

4. The method according to claim 3, wherein the collected network data for the at least one user is extracted from network data for a plurality of users.

5. The method according to claim 3, wherein the collected network data for the at least one user, the selected alarm, and the selected at least one threshold are associated with a user profile of the at least one user.

6. The method according to claim 1, wherein a priority of the generated event ticket is determined based on a priority matrix that assigned a priority level based on impact and urgency of the alarm.

7. The method according to claim 1, further comprising: providing a graphical user interface to the at least one user,
wherein the selection of the network quality category, the alarm, and the at least one threshold, is based on one or more selections made in the graphical user interface.

8. An apparatus for generating an event ticket, the apparatus comprising:
at least one memory configured to store computer program code; and
at least one processor configured to access said at least one memory and operate as instructed by the computer program code, the computer program code including:
first receiving, code configured to cause at least one of said at least one processor to receive for at least one user, a selection of a network quality category from a plurality of network quality categories;
second receiving code configured to cause at least one of said at least one processor to receive a selection of an alarm associated with the selected network quality category;
third receiving code configured to cause at least one of said at least one processor to receive a selection of at least one threshold for the selected alarm;
determining code configured to cause at least one of said at least one processor to determine a number of times the alarm is triggered within a predetermined time period; and
generating code configured to cause at least one of said at least one processor to generate the event ticket in response to a determination the number of times the alarm is triggered within the predetermined time period exceeds the at least one threshold.

9. The apparatus according to claim 8, wherein the plurality of network quality categories include one or more of (i) voice over long term evolution (Volte) rich communication services (RCS) voice quality, (ii) release cause anomaly, (iii) out of service, (iv) low reference signal received power (RSRP), (v) roaming, (vi) international mobile subscriber identity (IMSI) change, (vii) international mobile equipment identity (IMEI) change, and (viii) poor video quality.

10. The apparatus according to claim 8, wherein the determining the number of times the alarm is trigger is based on collected network data for the at least one user.

11. The apparatus according to claim 10, wherein the collected network data for the at least one user is extracted from network data for a plurality of users.

12. The apparatus according to claim 10, wherein the collected network data for the at least one user, the selected alarm, and the selected at least one threshold are associated with a user profile of the at least one user.

13. The apparatus according to claim 10, wherein a priority of the generated event ticket is determined based on a priority matrix that assigned a priority level based on impact and urgency of the alarm.

14. The apparatus according to claim 8, further comprising: providing a graphical user interface to the at least one user,
wherein the selection of the network quality category, the alarm, and the at least one threshold, is based on one or more selections made in the graphical user interface.

15. A non-transitory computer readable medium having instructions stored therein, which when executed by a processor cause the processor to execute a method performed by at least one processor for generating an event ticket, the method comprising:
receiving, for at least one user, a selection of a network quality category from a plurality of network quality categories;
receiving a selection of an alarm associated with the selected network quality category;
receiving a selection of at least one threshold for the selected alarm;
determining a number of times the alarm is triggered within a predetermined time period; and
generating the event ticket in response to a determination the number of times the alarm is triggered within the predetermined time period exceeds the at least one threshold.

16. The non-transitory computer readable medium according to claim 15, wherein the plurality of network quality categories include one or more of (i) voice over long term evolution (Volte) rich communication services (RCS) voice quality, (ii) release cause anomaly, (iii) out of service, (iv) low reference signal received power (RSRP), (v) roaming, (vi) international mobile subscriber identity (IMSI) change, (vii) international mobile equipment identity (IMEI) change, and (viii) poor video quality.

17. The non-transitory computer readable medium according to claim 15, wherein the determining the number of times the alarm is trigger is based on collected network data for the at least one user.

18. The non-transitory computer readable medium according to claim 17, wherein the collected network data for the at least one user is extracted from network data for a plurality of users.

19. The non-transitory computer readable medium according to claim 17, wherein the collected network data for the at least one user, the selected alarm, and the selected at least one threshold are associated with a user profile of the at least one user.

20. The non-transitory computer readable medium according to claim 15, wherein a priority of the generated event ticket is determined based on a priority matrix that assigned a priority level based on impact and urgency of the alarm.
